(19) United States
(12) Patent Application Publication
(10) Pub. No.: US 2010/0274674 A1
(43) Pub. Date: Oct. 28, 2010

(54) MEDIA NAVIGATION SYSTEM

(75) Inventors: Andrew F. Roberts, Melrose, MA (US); Raj Nair, Lexington, MA (US)

Correspondence Address: BAINWOOD HUANG & ASSOCIATES LLC, 2 CONNECTOR ROAD, WESTBOROUGH, MA, 01581, US

(73) Assignee: Azuki Systems, Inc., Acton, MA (US)

(21) Appl. No.: 12/821,323

(22) Filed: Jun. 23, 2010

Related U.S. Application Data
(63) Continuation of application No. PCT/US09/32565, filed on Jan. 30, 2009.
(60) Provisional application No. 61/024,642, filed on Jan. 30, 2008.

(51) Int. Cl. G06F 3/048; G06Q 30/00

(52) U.S. Cl. 705/14.73; 715/720

(57) ABSTRACT

A media navigation system provides a user interface for navigating and interacting with streamed media objects, including video. The system may employ media markers representing time locations within a media file in addition to images or other representations derived from the media object. The system displays a tile layout representing a sequence of the media at an interval comprising a set of sub intervals corresponding to the tiles, and enables a user to click on the tiles to navigate to a next set of tiles which correspond to a different interval, and which replace the currently displayed tiles on the display. Navigation can include zooming in (smaller interval), zooming out (larger interval) and “panning” (preceding or succeeding interval) at arbitrary intervals. Individual tiles may also include visual indicators of relative importance or activity such as the number of comments associated with a sub interval.

### BACKGROUND

The present invention relates to software for viewing and interacting with streamed media objects, including but not limited to video files.

Video playback devices, such as televisions, game consoles, song and video players, computers, and cell phones, provide controls for playing, pausing, rewinding, skipping, and varying the playback speed of the media. More recently, web-based applications such as YouTube provide additional controls for searching for videos and allowing viewers to associate comments with them. These applications also display advertisements and related messages before and after the viewing of videos, and also add “scrolls” of ads at the bottom of videos during playback.

Other media playback applications provide means of delivering “in picture” data during playback. In one application, a box is drawn around objects within frames during playback, and users can click on these boxes to pause the play, and display ads and related data.

Additionally, some DVD playback devices provide a user interface that displays a set of scene markers along with a set of characteristic still frames. The user can click on a frame and invoke playback of the video for that particular scene.

A project called “Hypervideo” at the FZ Palo Alto Laboratory, along with a function called “Detail on Demand”, provided a method for an application to automatically construct collections of small and medium sized clips of video from a larger media object, and then group and link these clips together into a structure providing for hierarchical navigation of the clips in a playback environment. The approach involved building a fixed hyperlinked collection of video objects in advance that could be navigated according to the way the clips had been sampled and linked at the time of construction by the software.

### SUMMARY

Existing media playback applications generally have a single representation of the content (e.g. video), and they provide a set of commands for jumping to different points in time along the timeline, and playing the video content. These applications generally lack an ability to present multiple representations of content for a specified interval. For example, one representation of data that is different from video is a set of images sampled from a video with some specified time spacing. A smaller time spacing may result in a higher density of images over some interval, whereas a larger spacing may result in a lower density of images, and hence a lower level of detail for the same interval. These different time spacings may result in multiple representations of the data of a media object over some specified interval.

Existing media playback applications lack an ability to present a choice of one of the multiple representations of media over an interval, whereby the level of detail provided by the representation is a function of the size of the interval on the time dimension (i.e. timeline), specified by the user. These applications generally provide no ability to zoom in on the time dimension, as one would do with a microscope when increasing the magnification associated with a portion of x-y spatial dimension, where the act of zooming in on a time interval would change the level of detail of information presented for the interval.

Existing applications also generally do not support ad hoc selection of arbitrary intervals on the time dimension through iterative panning and zooming operations.

Furthermore, these applications don't support displaying one of multiple representations of data corresponding to an interval, where the selection of the representation is a function of the size of the interval. The above-referenced DVD devices, for example, lack an ability to let the user select a location and recursively zoom in to identify different time intervals at different points in the video, and to see different collections of images and related data at these locations and intervals. The Hypervideo-based approach lacks an ability to provide an ad-hoc interval navigation mechanism that allows a user to navigate to any location and any interval size corresponding to the media. Instead, the navigation path is predetermined by the collection of links positioned at different points in time, and the target video lengths are predetermined at the time of their creation.

Existing media playback applications also lack an ability to associate related data (such as comments) with one or more of the representations of media associated with an interval. This may include comments associated with certain points in time that are presented along with a set of images that represent a specific interval.

Although social networking sites such as YouTube provide means of letting users comment on whole videos and songs, as well as comment on still images extracted from videos, these services and sites lack an ability to allow users to freely navigate to new locations, and intervals within the time dimension, and then associate new data with start and end times along this dimension.

Existing media playback applications also lack an ability to present a representation of a video that is conducive to browsing and casual interaction, similar to the way a person navigates a map by panning, and zooming to obtain greater or lesser levels of detail. A user cannot spend time casually interacting with a video without actually engaging in playing it. And then, when a video is played, the user is locked into attention with the real time playback stream, and he/she loses an element of control in digesting the stream of information at his or her own pace. In contrast, users of the World Wide Web spend hours stepping through collections of hyperlinked pages at their own pace. In a similar manner, users of interactive online maps can navigate to arbitrary regions, and zoom to arbitrary levels of detail. The fact that video playback has a tendency to lock a viewer's attention makes it difficult for existing playback applications to insert ads without disrupting playback and breaking the viewer's attention. In contrast to this, the casual interaction model afforded by the World Wide Web makes it easy for web sites to insert multiple ads during a session, and not distract or annoy the viewer.

Finally, existing media playback applications also lack an ability to tune the viewing and interaction behavior with a media object to fit the operating constraints of mobile devices. With mobile devices, users are often on the go, and are frequently distracted and interrupted. This makes it difficult for viewers to start videos and play them uninterrupted to their completion, especially if the videos are longer than several minutes. Existing mobile applications lack the ability to present alternative representations of a video whereby the content over several intervals is transformed into sets of easily digestible content (i.e. “glance able”), such as still images. Furthermore, these mobile applications lack an ability to navigate these intervals and present additional representations of data over sub intervals. Instead, mobile applications generally force the viewer to begin playing the video, and offer the only options to pause and resume play. The latter operating mode may require too much attention from a user if he or she is busy doing multiple tasks, which is common with mobile device usage. With existing mobile device media playback applications, the user cannot navigate to, and select an arbitrary location and interval in the time stream via a handful of clicks, receive collections of images sampled from the video over that interval, and then invoke commands to view and attach data related to the selected time stream.

A software system referred to as a “Media Navigation System” is disclosed. The Media Navigation System enables streamed media objects (including video and audio files) to be presented, navigated, and monetized via fixed and mobile computing devices, connected or disconnected from a network such as the Internet. Historically, video and audio have provided very few means of interaction. Audio and video playback applications provide only rudimentary controls for playing, pausing, rewinding, and changing the speed of playback. However, it is difficult for these applications to insert ads and provide hooks for links to other data, without distracting the user. When a user views or listens to a streamed media object, he or she typically doesn't want to be bothered by interfering data such as ads, because they disrupt the flow of the stream. In contrast to this, the World Wide Web, comprised of hyperlinked pages, enables people to navigate via a browser, and pause at their own pace. This more casual and disjointed form of interaction provides ample opportunities for web-based applications to insert ads and other distractions that are deemed acceptable. Furthermore, in addition to the general model of the World Wide Web where hyperlinks are predetermined, online mapping applications provide a form of ad hoc inquiry, where the user can choose to pan or zoom on arbitrary spatial intervals, and obtain any level of detail on any particular spatial interval.

The Media Navigation System provides a “game changing” approach to interacting with streamed media, by providing a generic means of navigating the time dimension of a stream, independent of the content associated with that stream in the media object. Existing navigation tools allow for navigating the content itself. For example, a user may jump around to different points in a video, or navigate to an index of scene markers or pre-packaged media snippets. In the same manner that a user might navigate through a set of pre-defined and linked pages on the web, existing approaches provide means of navigating chopped up, demarcated, and hyperlinked media objects. In contrast, the Media Navigation System provides a means of navigating a dimension (such as time) that is used to organize the content of a stream. This dimension may be referred to as an organizing dimension, and there may be multiple of these dimensions for a single media object, not limited to time. Furthermore, the Media Navigation System may produce dynamically derived collections of data corresponding to selected intervals along this dimension. These collections may be characterized as abstractions of the original content (such as video), and may comprise sets of images or text, sampled at different points along the organizing dimension. Separately, the system may extract and display data from one or more associated media objects (such as comments, notes, and images), and place this data in the context of the dynamically derived collections of data. With this approach, two different users can navigate stream dimensions of the same media object in unique ways, and reach different locations and intervals along this dimension, and obtain different dynamically derived sets of data representing these intervals.

The Media Navigation System provides a user interface for navigating and interacting with one or more streamed media objects, including video. The system first generates a set of media markers that represent time locations within a media file, in addition to an image, video and/or audio snippet that is derived from the media at each location. The system then arranges these markers in a “linear”, “tiled” or “flip book” style layout, where one of each media marker's images, or video snippets is displayed in a “tile”. The tile layouts represent one of a number of chronological sequences of the associated media markers, including a 1 dimensional sequence interpreted from left-to-right, a 2 dimensional sequence interpreted from left-to-right and top-to-bottom (i.e. A 3×3 tiled square), and a flip-book style sequence, where tiles or other sequences are overlaid on top of one another and are interpreted to flow into the page or screen. The system enables a user to click on tiles in the layout, and “zoom in” to a next set of media markers corresponding to a narrower window of time relative to a selected tile. When processing a “zoom in” command, the system replaces the current set of tiles with a new set of tiles. The new set of tiles corresponds to a narrow window of time in the vicinity of the selected tile. The system also provides commands to “zoom out” from a selected tile, and “slide sideways” from a tile. Sliding sideways is analogous to “panning”. These commands correspond to the zooming and dragging commands used to navigate a web-based map, with the difference being, in the present invention, these commands apply to the navigation of time locations within a media object, rather than geographic locations on a map.

Using this interface, a user can “zoom in”, “zoom out”, or “pan” to different time intervals within a video. For each interval, the user can also view the corresponding representation of tiles. This form of interaction is possible without requiring the user to “play” the media object (i.e., without requiring the use of start, pause, and rewind commands in order to reach a specific location). The system may also allow for an optional display of visual cues next to tiles to indicate the “density” of commented upon, or referenced media markers falling within a narrow time interval surrounding a tile. These visual cues enable the user to navigate to “hot spots” of interest. The system may also support commands to allow a user to add related data to media markers, such as tags, comments, and links (i.e. URLs), and optional insertion of ads. The selected media marker and its related data can drive the selection process of the ad, but it can also determine the price value of the ad based on the number of people who may have traversed that tile in the Media Navigation System. If the server monitors zoom and pan navigation paths, it can associate prices with highly trafficked time intervals, in a manner that is similar to how links on a web site work.

The Media Navigation System does not replace playback of streamed media objects. Rather, the approaches complement each other in that one can use the Media Navigation System to navigate to locations in time within a media object and then trigger playback of the media in the context of this location.

Although the description herein is primarily focused on time as the navigable dimension of the stream, in alternative embodiments other dimensions may be navigated. For example, the Media Navigation System may provide navigation of a stream, such as a video, based on a location dimension. Portions of a video may be tagged with geospatial information. One can zoom in to different points within the stream, and narrow the interval around that position, and then separately have the system pull in related data from one or more related media objects—relevant to this position and interval. In another embodiment, the system can provide navigation of a stream based on a “color dimension”. Portions of a video may be tagged with color tags indicating the presence of predominant colors spanning different frames over different intervals. As the user zooms into a region of the color dimension using a color wheel navigation interface, the system selects collections of tiles associated with the intervals closely associated with those colors. Separately, such system may pull in articles searched from common news sites referencing a particular color falling within the interval and location of the current stream interval.

As an example of use of the system, in one scenario a football game may be presented in a Media Navigation System. At the top level, a user might see a collection of several tiled images derived automatically by the software to provide visual snapshots at fixed intervals, or interesting moments throughout the game. Using the Media Navigation System, the user can click on each tile and obtain a next level of tiles collectively representing the interval of the selected tile. Each new tile shows an image derived from the time interval associated with the originally selected tile. A user can quickly navigate up and down the stack, as well as horizontally, and trigger playing of snippets of the game from various tiles—without having to watch the whole game. Additionally, a user may be able to view comments and links to related data associated with various tiles. The user may also be able to create a clip by selecting start and end location tiles, and then send a link of this representation of the interval to a friend. A user could also add a comment to a tile, or create a link requesting a tile representation of some time interval of a media object from another Media Navigation System (e.g., a URL defining a Media Navigation System, a media object, and time interval references). Furthermore, throughout the use of the Media Navigation System, the system may track the navigation paths and serve up context specific ads between displays of different collections of tiles. The selection of these ads may be driven by the popularity of tiles being traversed, and the pricing of these ads may be driven by the traffic statistics collected across a community of users navigating one or more Media Navigation System instances.

Other features and advantages of the system will be apparent based on the detailed description below.

### BRIEF DESCRIPTION OF THE DRAWINGS

FIGS. 1a and 1b are block diagrams of a media navigation system in accordance with embodiments of the present invention;

FIG. 2 is a diagram depicting a media object and related data;

FIG. 3 is a diagram depicting presentation of tiles to a user during media navigation;

FIG. 4 is a specific example of a presentation of FIG. 3;

FIG. 5 is a flow diagram showing operation of a client in the media navigation system;

FIG. 6 is a flow diagram showing operation of a server in the media navigation system;

FIGS. 7a-7c are diagrams showing the relationship between a main interval and sub-intervals of a media object in different embodiments;

FIGS. 8a-8c and 9 are diagrams showing different layouts that can be used in the presentation of tiles to a user.

### DETAILED DESCRIPTION

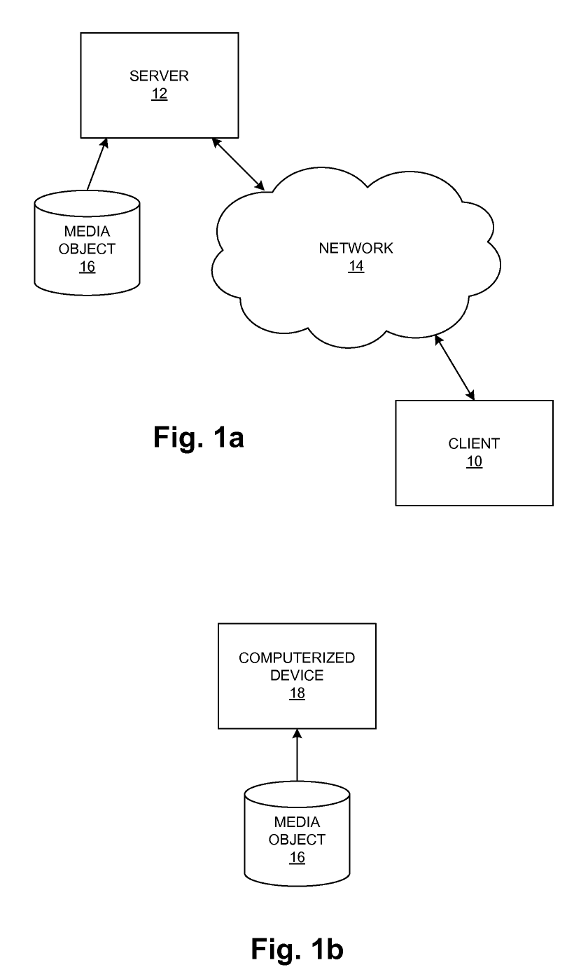

A software system is disclosed which may, in one embodiment, be realized by a server and a client communicating via a network. The system is referred to herein as a Media Navigation System. Referring to FIG. 1a, a client 10 may be a web-based browser running on a personal computer or similar computerized device and communicating to one or more servers 12 via a network 14 such as the Internet. The server(s) 12 are computerized devices having access to stored media objects 16 such as video clips, audio clips, etc. The client-server communications may employ a standard protocol such as Hypertext Transfer Protocol (HTTP) along with a suitable application programming interface (API), which may be representational state transfer (REST)-based API. As shown in FIG. 1b, in another embodiment the system may provide all functions in a self-contained application operating on a single computerized device 18. The computerized device 18 may be a mobile device such as a smart phone, or it may be another type of device such as a set top TV box, game console, or computer. The system may also utilize an API to gain access to a collection of media files. Such an API may include a file system, a database, or an Internet protocol. The term “computerized device” as used herein refers to devices capable of running application programs, typically including a processor, memory, storage (such as a hard disk or flash memory), and input-output circuitry. In the system of FIG. 1a, the client 10 and server 12 include network interface circuitry to effect communications in the network 14, and the client 10 includes a user display device such as an LCD screen. In the system of FIG. 1b, the single device 18 also includes a user display device.

In the following description, references to the “client” should be understood as referring to the client 10 in an embodiment of the type shown in FIG. 1a, and to the portion on the single device 18 that performs the client-like functions (e.g., user interface, formulating data requests) in an embodiment of the type shown in FIG. 1b. Similarly, references to the “server” should be understood as referring to the server 12 in an embodiment of the type shown in FIG. 1a, and to the portion on the single device 18 that performs the server-like functions (e.g., receiving data requests, formulating and sending data responses) in an embodiment of the type shown in FIG. 1b.

One feature of the system is to provide an interactive user interface for viewing and editing representations of media objects 16 and the data related to these objects. Media objects 16 may include raw video files, assembled collections of video files (e.g. play lists and view lists), as well as any other type of data structure that represents a sequentially organized set of data items that is typically played in a media player, wherein the basis of a sequence may be time. Data related to media objects 16 may comprise metadata tags, as well as data values of any given type, including, but not limited to comments, links, and names. Said viewed and edited representations of media objects 16 may comprise sets of still images, audio or text snippets. In one embodiment, these representations may be derived using an automated method, or they may be manually assigned to said representations of media objects 16 by a person.

### Media Navigation System Structure

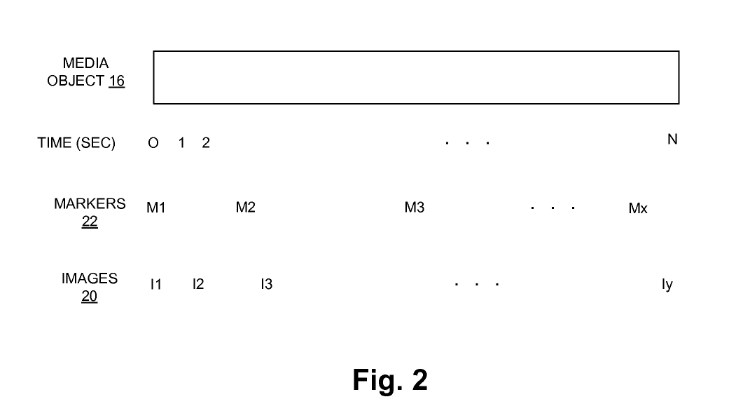

FIG. 2 shows a depiction of a media object 16 and a corresponding time duration (TIME) that it spans. A media object 16 may be in any of a variety of formats which are generally known, for example MPEG or AVI formats, and these formats as well as the applications that utilize them generally allow for a time-based access to the data of the media object 16. Generally, the Media Navigation System scans a media object 16 and derives a set of data objects that are used for navigation and other purposes. The data objects may include still images 20 (shown as IMAGES I1, 12, . . . ) for video objects (or audio clips for audio objects), where the images are taken from certain time points of the media object 16. Different approaches for deriving the images are described below. The data objects may also include media markers 22 (shown as MARKERS M1, M2, . . . ) that identify times at evenly spaced intervals (e.g. 1 second intervals), or times of particular interest, such as the beginning of particular scenes or events occurring within the video. The markers 22 may be associated with respective time intervals which are windows of time in the media object 16 located relative to the associated media markers 22. The markers 22 may also be associated with respective ones of the images 20 which are selected as being representative of the content of the media object 16 at the respective time intervals. One can think of the derived data associated with a media marker 22 and time interval as being a characterization, or representation, of the data contained within the specified interval in the media object 16.

Although not depicted in FIG. 2, the media markers 22 may have a hierarchical aspect, that is, there may be markers 22 that are logically subordinate to other markers 22. For example, there may be markers at one level for major divisions of a video (e.g., different quarters of a football game), and then markers at a lower level for sub-intervals of the major divisions (e.g., different possessions by the teams within a quarter), as well as markers denoting specific events (e.g., tackles, fumbles and touchdowns).

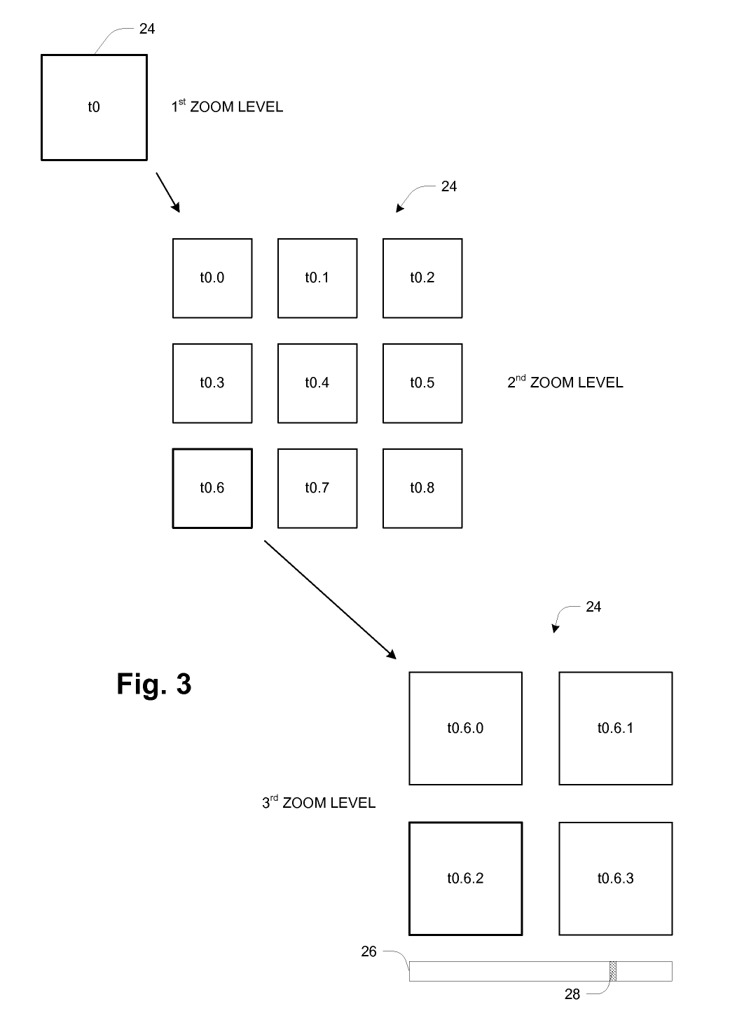

FIG. 3 illustrates one basic operation of the Media Navigation System. The system organizes and presents “tiles” 24 in a graphical layout within the structure of a computer-based user interface, such as the display device of client 10 or device 18 of FIGS. 1a and 1b. In one embodiment, this user interface may be a widget displayed in a browser, or it may be an application displayed on a set top box or Internet connected game console, or mobile device. The tiles 24 generally include at least a snippet of a media object 16 that is the subject of navigation. For example, for a video media object 16 each tile 24 may include a corresponding one of the images 20 derived from the media object 16. The tiles 24 correspond to portions (such as distinct time intervals) of the media object 16. In the illustrated embodiment, the tiles 24 have a hierarchical relationship reflected in a hierarchical tile numbering scheme. The tiles are generally numbered using an “x.y.z” format, where each number identifies one of a set of tiles at each “zoom level”. Thus the tile t0.6.1, for example, identifies a third zoom level tile which is the second of four tiles under a second zoom level tile t0.6, which itself is a the seventh of nine tiles under the first zoom level tile t0.

The tiles 24 of a given zoom level provide a finer-grained representation of the same portion of the media object 16 that is provided by a corresponding single tile 24 at the next higher zoom level. Thus the single tile t0 at the first zoom level represents the whole media object 16, which is also represented by the entire collection of tiles t0.0-t0.8 at the second zoom level. Each individual tile at the second zoom level, for example the highlighted tile t0.6, represents one of nine portions of the whole media object 16, and each individual tile at the third zoom level represents one of four portions of a corresponding time interval associated with a tile of the second level (i.e., roughly one thirty-sixth of the entire media object 16). It will be appreciated that in any particular embodiment there is a relationship among the size of the media object 16, the granularity/resolution of the tiles 24 at the lowest zoom level (the lowest level occurs when the time interval associated with a tile cannot be further subdivided without creating sub-intervals with the same data representation), the number of tiles displayed at each zoom level, and the number of zoom levels.

FIG. 3 also shows the use of a graphical aid such as a bar 26 that includes an indicator 28 showing the location and extent of the media corresponding to the either the currently selected tile 24, or current main interval represented by the collection of tiles at a zoom level. The bar 26 is only shown in connection with the third zoom level in FIG. 3 in order to reduce clutter in the Figure; it will be appreciated that the bar 26 would ideally be displayed at all zoom levels to provide maximum usefulness to a user.

A specific example is now given to more specifically describe the scheme illustrated in FIG. 3. Two zoom operations may be applied to an initial tile t0 and result in a display of tiles t0.6.0-through t0.6.3. Tile t0 may start with an interval called int0 of duration 250 seconds and may include a media marker called m0 at 0 seconds. As such, tile t0 may represent a 250 second long video file starting at the beginning of the file. At the first zoom level, the seventh tile in the sequence, called t0.6, has an interval called int0.6 of 27.8 seconds duration and includes a media marker called m0.6 at the 166.7-second point of the video. The tile t0.6 corresponds to a video clip from the referenced media object 16 beginning at 166.7 seconds into the video and having a duration of 27.8 seconds. A zoom operation applied to the seventh tile t0.6 may produce a next display of four tiles, wherein the second tile from this set, called t0.6.1, may have a time interval called int0.6.1 of 6.9 seconds duration and a media marker called m0.6.1 at 173.6 seconds. This corresponds to a video clip beginning at 173.6 seconds into the video file and having a duration of 6.9 seconds.

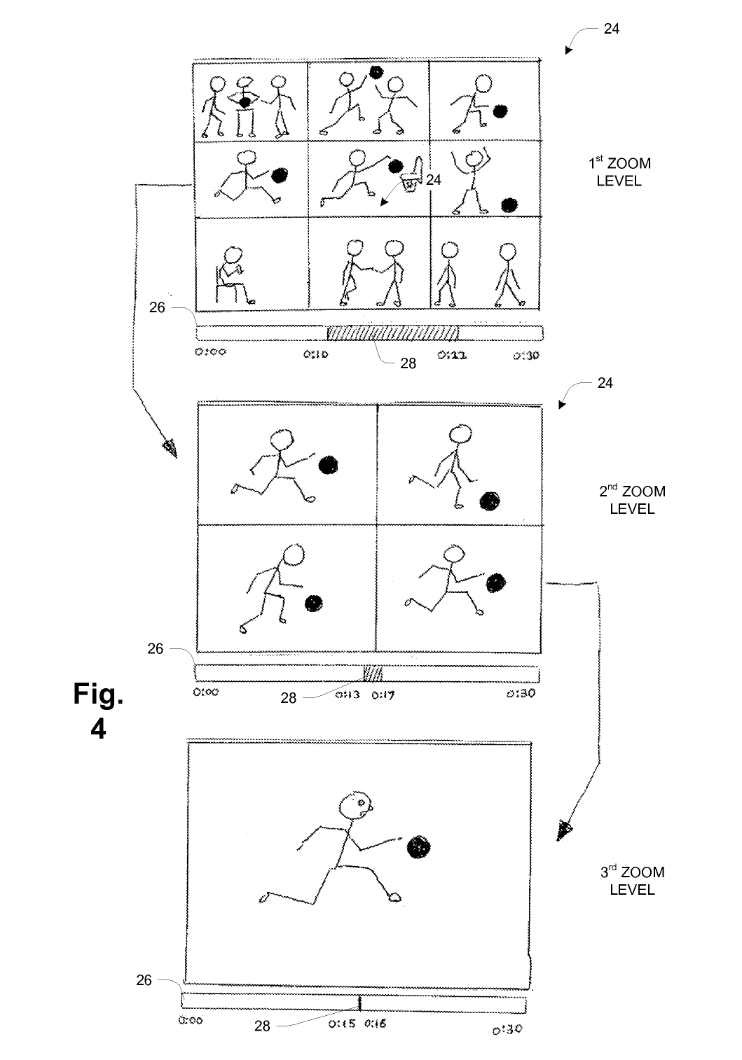

FIG. 4 is a depiction of a navigation sequence as in FIG. 3 but including real images. The first zoom level shows tiles and images representing segments of a basketball game. The second level shows tiles and images representing more detail of the interval corresponding to the fourth tile of the first zoom level, and the third level shows a single tile image representing the fourth tile of the second zoom level. The progression of the indicator 28 within the bar 26 is also shown, with the indicator 28 growing progressively smaller at the greater zooms of levels 2 and 3. If the user selects “play” at zoom level three, then the video for only this specific section of the video of the basketball game is played.

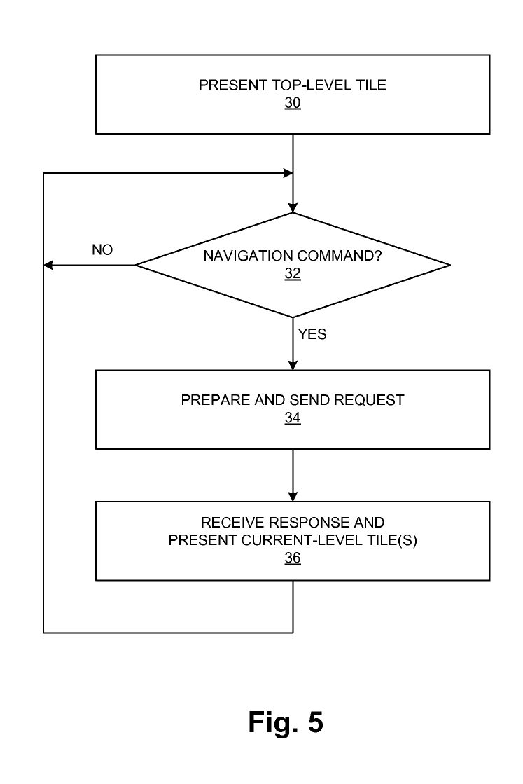

FIG. 5 is a flow diagram showing the high-level operation of the Media Navigation System client 10 of FIG. 1, such operation being reflected in the example of FIG. 3 discussed above. At step 30, the client 10 presents a top-level tile 24 to the user, for example by displaying an image 20 and perhaps other related graphical aspects of the tile 24 on a user display. At step 32 the client 10 awaits a navigation command by the user, which may be, for example, a “zoom in” command with the top-level tile 24 being selected. Upon the user's execution of a navigation command, at step 34 the client 10 prepares and sends a request to the server 12 for a set of data objects, over a new time interval, that represent a new set of tiles 24 that will be displayed. The user's execution of the navigation command may correspond to a selection signal within the client 10 that indicates that the user has selected a tile which is the subject of the navigation command. The request may be in HTTP form such as a Get request and may contain URL resource identifiers in addition to other parameters. An example of a URL is “/medias/123” which corresponds to a media object 16 whose identifier is 123. Examples of parameters include a requested main interval range, which may be specified for example as &range=[10,144] where the numbers within the brackets identify the start and end times of the main interval. In addition, the request parameters may contain an explicit quantity which corresponds to the number of desired sub intervals, or tiles, to be returned. As a specific example continuing the example of FIG. 3, a request generated in response to a “zoom in” command for tile t0.6 identifies the main interval as [166.7, 194.5], and may explicitly identify “four” as the number of sub-intervals to be returned.

At step 36, the client 10 receives a response to the request and then uses the response data to generate and present a new set of tiles 24 to the user (referred to in FIG. 5 as “current level tiles”). The tiles may be displayed in a grid such as depicted in FIG. 3, or in other cases it may use another approach to the display (examples discussed below). Each displayed tile 24 is generated from and represents the response data for a corresponding one of several sub intervals of the main interval identified in the request. Note—the sub intervals need not be evenly spaced or have identical durations. The client 10 may display an image 20 as part of each tile 24, and may also display one or more tile overlay images to represent additional data. For example, an icon might be displayed indicating the relative density of references to that sub interval as a percentage of references to all sub intervals. If a graphical aid such as bar 28 and indicator 28 are in use, then the client 10 may also update that graphic to reflect the relative size and location of the current main interval relative to the start and end times of the whole media object 16. In addition, if a user selects a tile, the client may update the graphic to reflect the relative size and location of the tile's sub interval relative to the main interval represented by the collection of tiles.

In some embodiments the client 10 may also present a set of user interface controls that invoke additional requests, such as “zoom” requests (traverse hierarchy vertically) or “pan” requests (traverse horizontally). The client 10 may associate the click action on each tile 24 with a particular request, such as a zoom in request, for the sub interval. The client 10 may also present separate buttons for zooming out and panning to the left and right relative to the current main interval. The client may allow a user to select a tile and then activate one of a number of commands relative to the tile's interval, such as playing the video for a predetermined portion of time starting at that tile interval, or navigate to a collection of comments associated with the selected tile interval.

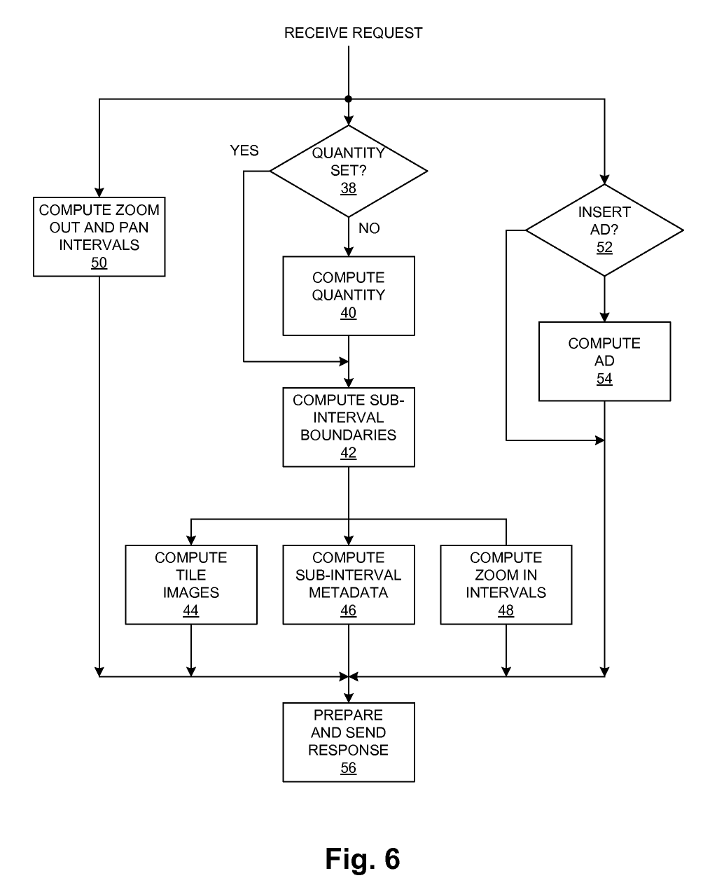

FIG. 6 is a flow diagram showing the high-level operation of the Media Navigation System server 12 of FIG. 1. The server 12 receives a request containing request data which identifies a media object (using a name, id, or other identifying pattern) and optionally a main interval and a quantity parameter which defines the number of sub intervals that the requested main interval is to be broken into. The receipt process may also include identifying and authenticating the requestor. If no main interval range is specified, then the server 12 may set the main interval to be [0,MAX] where MAX is the length of the media object.

At step 38 the server 12 determines whether a request includes a quantity parameter. If not, then at step 40 the server 12 computes a quantity. One approach for computing a quantity is based comparing the length of the requested main interval with one or more predetermined thresholds. If the main interval length is less than a first threshold duration, such as 4 seconds for example, then the quantity may be set to a first value such as one. If the length is between the first threshold duration and a second threshold duration, such as 9 seconds for example, then the quantity may be set to a second value, such as four. If the length is greater than the second threshold duration, then the quantity may be set to a third value, such as nine. This approach allows for a variable number of sub-intervals to be returned, enabling the client 10 to vary the sizes of the displayed tiles 24 to make most effective use of the display area (i.e., when fewer sub-intervals are returned then correspondingly fewer tiles 24 are displayed and thus can be made larger, such as illustrated in FIG. 3 between zoom levels 2 and 3). Another approach is to set the quantity according to a lookup table that returns a quantity for an input percentage, where the percentage is the ratio of the interval length to the length of the media object. Other approaches for setting quantity may take into consideration external parameters, such as a type of device that a user may be using to view tiles.

At step 42 the server 12 computes sub-interval boundaries based on the quantity, either as provided in the request or computed in step 40. Details of this computation are provided below. As part of this computation, the server 12 may determine whether there is a collection of pre-existing markers 22 for the requested media object 16. A marker 22 may comprise a defined interval and location somewhere along the time dimension of a media object 16, in addition to a label and tags that provide information about the content of the media object 16 within the interval. The server 12 may filter the set of markers 22 to only include ones that have respective intervals smaller than the requested main interval and that partially or entirely fall within the main interval.

The server 12 may initially divide the main interval into a set of uniformly spaced and sized sub intervals according to the quantity. For example, if the main interval is the range [0, 250] and the quantity is 9, then this step might create nine sub-intervals of ranges [0, 27.8], [27.8, 56.6], . . . , [222.2, 250]. Next, the application may adjust or “snap” the locations of these sub-interval boundaries such that they coincide with some of the start times of the filtered set of markers 22, so that the returned sub-intervals correspond to more interesting times within the media.

The server 12 may begin the sub-interval computation process by evaluating the first or earliest sub interval boundary. For this boundary, the server 12 may first find all the markers 22 whose intervals either contain, or are sufficiently near the sub interval boundary. Next, the server 12 may select from this set the marker 22 whose start time is closest to the sub interval boundary. Next, the server 12 may change the location of the sub interval boundary to coincide with the start time of the selected marker, provided that the new location does not cause the sub interval boundary to either jump to a time earlier than a preceding sub interval boundary or snap to the same point as the preceding boundary. One goal may be to insure that no boundaries collapse to form zero length sub intervals.

The server 12 may then continue to process the remaining sub interval boundaries in the order of their increasing time in a similar fashion as for the first sub-interval boundary.

After computing the sub-interval boundaries, the server 12 performs several steps shown at 44, 46 and 48. At step 44, the server 12 computes the identity of a tile image 20 for each sub interval, by referencing a repository of ingested tile images 20 such as described above with reference to FIG. 2. The server 12 may access said repository with the sub interval start and end times and derive the identity of a tile image 20 that appropriately represents that sub interval. In one approach, there may be tile images 20 in the repository corresponding to each fraction of a second. The server 12 may select from the repository the image 20 whose time is closest to the start time of the interval. Alternatively, the server 12 may select an image whose time corresponds to some important time within the sub interval. An important time may be the time where the largest number of image retrieval requests has taken place over the past N hours, for example.

At step 46, the server 12 computes sub-interval metadata, which is auxiliary information relevant to each sub interval. This information may include a count of the number of references to each sub interval, where references might include comments created by system users that have time references to the media object. More information about comments is provided below. Additional metadata may include a set of tags associated with the markers 22 whose intervals fall within the sub interval boundaries. Counts of references and tag values may be used later to provide users with indications of “hot” or “important” sub intervals relative to the overall set of computed sub intervals.

At step 48, the server 12 computes a zoom-in interval for each computed sub-interval. Each zoom-in interval can be used in a subsequent formatted request that the client 10 can send to the server 12 to specify a new main interval that is coincident with the current sub interval. This request would have the effect of zooming in on the sub interval, making it the new main interval. The server 12 can provide this zoom-in interval back to the client 12 for the client's later use in response to a subsequent user zoom-in operation.

In step 50, the server 12 may compute zoom-out and pan intervals which can be used in subsequent formatted requests that the client 10 can send to the server 12 to specify a new main interval. For the zoom-out command, the computed zoom-out interval is a super-interval that is larger than the current main interval but also includes it. For example, the computed zoom-out interval may be an interval nine times longer and centered on the current main interval if possible. The server 12 may ensure that the new main interval is contained within the start and end times of the media object 16. This request would have the effect of zooming out on the current main interval to a new larger main interval that contains the current main interval.

The pan intervals computed in step 50 specify a new main interval that is adjacent to one side of the current main interval. Taking time as the pertinent dimension, a “pan left” may correspond to changing the main interval to an immediately preceding like-size interval, and a “pan right” may correspond to changing the main interval to an immediately succeeding like-size interval. The server 12 may ensure that the new main interval is contained within the start and end times of the media object. This request would have the effect of panning to the “left” (earlier) or to the “right” (later) of the current main interval.

At step 52 the server 12 determines whether it is to insert an advertisement into the response so that it may be displayed to the user by the client 10. As described elsewhere herein, the ad may be displayed in any of a variety of ways, including for example inserting such an ad as a separate “sub-interval” (to be treated and displayed in the same way as media sub-intervals by the client 10) or as a replacement for one of the media sub intervals computed in steps 42-44. An ad may comprise a link to an ad image to be displayed, along with a link. The server 12 may retrieve the set of tags associated with the media object 16, as well as derive the set of markers 22 that fall within the main interval. From this set of markers 22, the server 12 may augment the set of tags and weight these in order of their frequency. The server 12 may then select an ad whose associated tags best match the derived weighted set.

In step 56, the server 12 prepares return data by packaging the computed images, metadata, zoom and pan requests and ad data into a response and returns this response to the client 10. The response may be formatted in Extensible Markup Language (XML) or JavaScript Object Notation (JSON) and returned as an HTTP Response to the Get request.

### Media Navigation Data

As mentioned above, the response returned by the server 12 may be in the form of an XML document. In one representation of this data, the XML may be structured according to the following table, which specifies tags and their associated meanings/descriptions:

TABLE 1
RESPONSE DOCUMENT STRUCTURE

| TAG | DESCRIPTION |
|---|---|
| <multimedia> | The root element of the document containing information about |
| | the media object, the main interval, and sub intervals |
| <media_length> | The length in seconds of the media object |
| <media_title> | The title of the media object |
| <main_range> | The information describing the main interval, including the set |
| | of sub intervals |
| <start> | The start time in seconds of the main interval |
| <end> | The end time in seconds of the main interval |
| <comments> | The number of comments that reference the main interval |
| <sub_ranges> | The element that contains the set of sub range elements |
| | describing each of the sub intervals |
| <sub_range> | An element that describes a sub range |
| <media_type> | The description of the type of media represented by the sub interval |
| <start> | The start time in seconds of the sub interval |
| <end> | The end time in seconds of the sub interval |
| <comments> | The number of comments that reference the sub interval |
| <media> | The URL for the “zoom in” command associated with the sub interval |
| <image> | The URL for the image associated with the sub interval |
| <prev_range> | The element that describes the “pan left” command |
| <start> | The start time in seconds of the “pan left” main interval |
| <end> | The end time in seconds of the “pan left” main interval |
| <media> | The URL for the “pan left” command |
| <next_range> | The element that describes the “pan right” command |
| <start> | The start time in seconds of the “pan right” main interval |
| <end> | The end time in seconds of the “pan right” main interval |
| <media> | The URL for the “pan right” command |
| <out_range> | The element that describes the “zoom out” command |
| <start> | The start time in seconds of the “zoom out” main interval |
| <end> | The end time in seconds of the “zoom out” main interval |
| <media> | The URL for the “zoom out” command |
| <ad_id> | The id of an ad associated with the return data |
| <ad_url> | The URL to the ad when the ad image is clicked |
| <ad_banner> | The URL to the image of the ad |

Below is provided a specific example of a response document which is structured according to the scheme of Table 1 above. In this example, the response identifies nine sub-intervals of a media object entitled “Swimming” having a duration of 193 seconds.

```
<multimedia>
  <media_length>193</media_length>
  <media_title>Swimming</media_title>
  <main_range>
<start>0</start>
<end>193</end>
<comments>30</comments>
<sub_ranges>
  <sub_range>
    <media_type>Video</media_type>
    <start>0</start>
    <end>15</end>
    <comments>0</comments>
    <media>http://x.com/medias/cz_ad/2?media_src_id=1</media>
    <image>/image/mobile/clickzoom/2/s/2.jpg</image>
  </sub_range>
  <sub_range>
    <media_type>Video</media_type>
    <start>21</start>
    <end>42</end>
    <comments>0</comments>
    <media>http://x.com/medias/navigate/1.xml?range=[21,42]&ad_id=821</media>
    <image>/image/mobile/clickzoom/1/s/23.jpg</image>
  </sub_range>
  <sub_range>
    <media_type>Video</media_type>
    <start>42</start>
    <end>63</end>
    <comments>3</comments>
    <media>http://x.com/medias/navigate/1.xml?range=[42,63]&ad_id=821</media>
    <image>/image/mobile/clickzoom/1/s/44.jpg</image>
  </sub_range>
  <sub_range>
    <media_type>Video</media_type>
    <start>63</start>
    <end>84</end>
    <comments>1</comments>
    <media>http://x.com/medias/navigate/1.xml?range=[63,84]&ad_id=821</media>
    <image>/image/mobile/clickzoom/1/s/65.jpg</image>
  </sub_range>
  <sub_range>
    <media_type>Video</media_type>
    <start>84</start>
    <end>105</end>
    <comments>0</comments>
        <media>http://x.com/medias/navigate/1.xml?range=[84,105]&ad_id=821</media>
      <image>/image/mobile/clickzoom/1/s/86.jpg</image>
      </sub_range>
      <sub_range>
        <media_type>Video</media_type>
        <start>105</start>
        <end>126</end>
        <comments>0</comments>
        <media>http://x.com/medias/navigate/1.xml?range=[105,126]&ad_id=821</media>
        <image>/image/mobile/clickzoom/1/s/107.jpg</image>
      </sub_range>
      <sub_range>
        <media_type>Video</media_type>
        <start>126</start>
        <end>147</end>
        <comments>7</comments>
        <media>http://x.com/medias/navigate/1.xml?range=[126,147]&ad_id=821</media>
        <image>/image/mobile/clickzoom/1/s/128.jpg</image>
      </sub_range>
      <sub_range>
        <media_type>Video</media_type>
        <start>147</start>
        <end>168</end>
        <comments>1</comments>
        <media>http://x.com/medias/navigate/1.xml?range=[147,168]&ad_id=821</media>
        <image>/image/mobile/clickzoom/1/s/149.jpg</image>
      </sub_range>
      <sub_range>
        <media_type>Video</media_type>
        <start>168</start>
        <end>193</end>
        <comments>10</comments>
        <media>http://x.com/medias/navigate/1.xml?range=[168,193]&ad_id=821</media>
        <image>/image/mobile/clickzoom/1/s/170.jpg</image>
      </sub_range>
    </sub_ranges>
  </main_range>
  <prev_range>
    <start>0</start>
    <end>193</end>
    <media>http://x.com/medias/navigate/1.xml?range=[0,193]&ad_id=821</media>
  </prev_range>
  <next_range>
    <start>0</start>
    <end>193</end>
    <media>http://x.com/medias/navigate/1.xml?range=[0,193]&ad_id=821</media>
  </next_range>
  <out_range>
    <start>0</start>
    <end>193</end>
    <media>http://x.com/medias/navigate/1.xml?range=[0,193]&ad_id=821</media>
  </out_range>
  <ad_id>821</ad_id>
  <ad_url>http://smn.adnetwork.com/cola/</ad_url>
  <ad_banner>/image/cola.jpg</ad_banner>
</multimedia>
```

### Derivation of Media Navigation System Data

As described above, an initial tile t0 may correspond to an image 20, one or more media markers 22, and time interval into. When a user selects tile t0 and applies a “zoom in” command, the system may derive a new set of tiles to replace the current view of tiles (wherein the current view contains tile t0). This new set of tiles may be associated with a “level” which represents the number of zoom in operations performed relative to a first tile to.

A derived set of tiles may have a “grid size” (represented by the symbol GS), which represents the number of tiles in the new set. The new set of tiles may be identified using a notation wherein the new entities use names from the previous level with the addition of a period followed by a sequence number, for example falling in the range from 0 to GS−1. In the example of FIG. 3, the zoomed-in set of tiles for top-level tile t0 has names corresponding to t0.0 through t0.8, with a grid size GS of 9. This corresponds to a set of nine tiles suitable for display in a 3×3 grid.

The method used to derive the grid size GS and interval size of each tile in the new derived set as part of a “zoom in” command may be of a linear or non-linear nature. In one embodiment, a linear approach may involve deriving a GS value for the new set by taking the same value as the previous set. This would cause all sets to have the same number of tiles. Thus, each zoom level other than zoom level 1 might have GS=9. In addition, this linear approach may also cause each of the tiles in a set to have the same time interval, where the time interval value is derived by dividing the previous selected tile interval by the GS value.

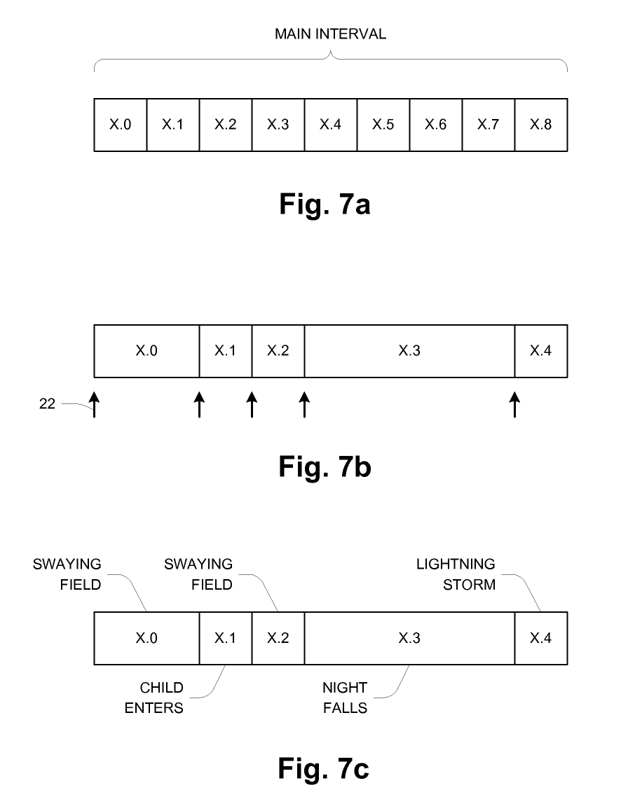

FIG. 7a illustrates a linear derivation method for tile intervals and media markers. The main interval becomes divided into equal-size sub-intervals (shown as x.0, x.1, etc. in FIG. 7a), and the technique may be represented by a set of equations for deriving the jth interval and jth marker in the current zoom level from the ith interval and ith marker of the previous level, as follows:

Interval inti.j=(inti)/GS and marker mi.j=mi+j*(inti.j).

The specific example discussed above with reference to FIG. 3 illustrates the above linear derivation method.

A non-linear interval derivation approach may be used in which the number of tiles at a particular zoom level may be derived by some other criteria than simply dividing the preceding level into a fixed number of equal-size intervals. FIGS. 7b and 7c illustrate examples of sub-interval definitions that can result from non-linear techniques. In one case, the method may start with the linear method but then adjust or “snap” the boundaries of the sub-intervals to nearby markers 22, which presumably helps make each sub-interval more of a complete unit. These markers 22 may have been established as part of an “ingestion” process performed on the media object 16 when it is first made available to the Media Navigation System for user access. Such markers 22 may indicate certain structured divisions of the media object 16, for example different major scenes or segments, and sub-scenes or sub-segments within each scene/segment, and may be created by a human or machine-based (software) editorial process. The markers 22 may also be created by applying a pattern matching rule to the video frame data within the media object 16. For example, the system may scan the frame data from a media object 16 beginning at a specified media marker 22 and proceeding for a specified time interval, looking for pixel-level patterns depicting the presence of a specific person's face using pattern-matching rules tailored for face detection. The pattern detection portion of the overall method may be performed by an external service, and the media marker results may be provided back to the Media Navigation System. This method may result in a set of markers 22 corresponding to the times that a camera switches to a person's face, for example in an interview when focus shifts to the person to answer a question. As a result of a derivation process of this type, the interval length of each tile may correspond to the amount of time that passes until the next occurrence of a media marker where such face appears again. Such a non-linear interval derivation method may produce a set of intervals of varying length.

An alternative non-linear interval derivation method may use an activity threshold algorithm to automatically detect a location in a media object 16 whereby a sufficient amount of activity has taken place since a start location. An example of a resulting sub-interval definition is shown in FIG. 7c for a video of a swaying field of grass. In a first sub-interval x.0, a long period of time elapses which shows only swaying grass. At some point, sufficient different activity occurs to trigger the generation of a media marker signaling the end of a sub-interval. Such a threshold may be reached when a child runs into the field, for example (sub-interval x.1), causing higher levels of activity as might be measured by relative change between successive frames. Additional sub-intervals may be defined by a return to swaying grass, nightfall, and a lightning strike.

In one embodiment, a threshold of activity may be measured by calculating an average color-based score for each video frame, and then comparing neighboring frames to look for large changes in the average score. By using a color averaging method, changes such as swaying grass would have little effect in the change from frame to frame, but the presence of a new, sufficiently large object would affect the average color score enough to trigger an activity threshold. Such a method would be useful in automatically dissecting a media object 16 into a set of tiles corresponding to self-contained units of distinct activity, such as the plays in a football game.

The method of deriving tile data may take place at the time a request is made to invoke and display a Media Navigation System relative to a subject media object. The derivation may also take place prior to any such requests, and the data may be cached or stored for access without requiring presence of the media object.

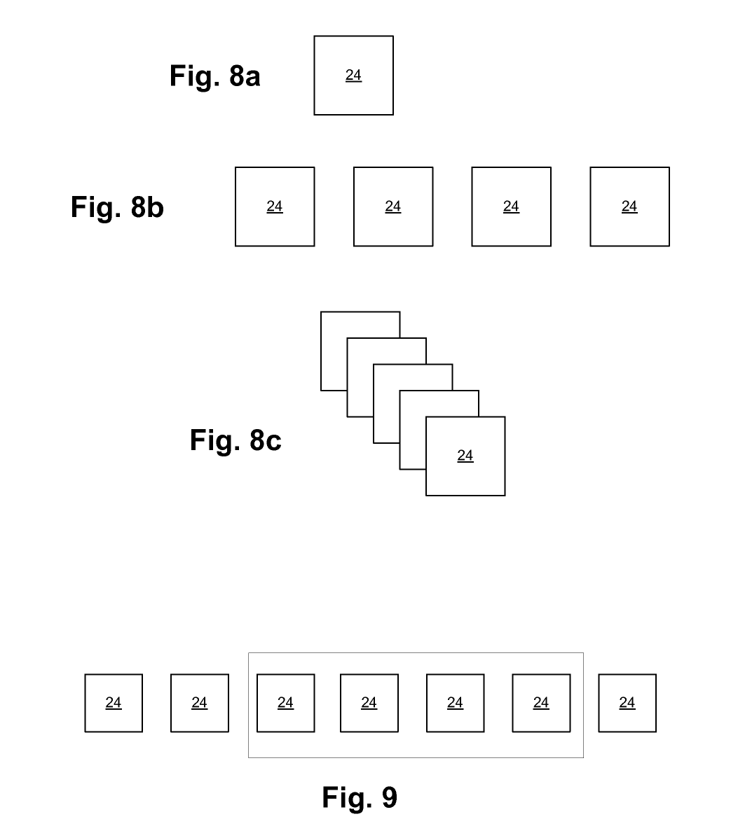

Referring now to FIGS. 8a-8c, tiles may be arranged according to a number of different layouts. These may include a zero-dimensional layout (FIG. 8a) wherein only a single tile is displayed (and any additional tiles are “underneath” the displayed tile). Another layout is a one-dimensional layout (FIG. 8b) wherein a line of tiles is displayed along a vector, for example in the x-y plane of the computer display. Another layout is a two-dimensional layout wherein tiles are arranged in an m×n grid reading from left to right and top to bottom, such as shown in FIG. 3. Within layouts, tiles may optionally overlap. An example of an overlapping linear display is shown in FIG. 8c. The layouts are intended to convey the sequence of media markers associated with the tiles. For example, in an m×n grid layout of tiles, the user may interpret this to show a time-based sequence following a raster-type progression starting at the top left and progressing to the bottom right.

FIG. 9 illustrates another possible display option which may be utilized when the complete set of tiles at a particular zoom level may not fit within the display space. For example, in the case of a one-dimensional linear display, there may only be enough room to display four out of seven tiles from a derived sequence. The system may provide a command to advance the display to a next or previous group of tiles within the set. These commands may be considered to be “horizontal” in nature because they navigate the existing set of derived tiles without causing the system to derive a new set of tiles.

### Media Navigation System Data Content

The system may additionally provide a means of storing data related to one or more media markers associated with a media object. In one embodiment, this data may comprise references to records in a database. Such a database may additionally provide means of storing a variable number of data items associated with each media marker and media object. In another embodiment, this data may include typed data structures where the schema of such typed data is described by an XML schema, and where the data may be stored in an XML repository. This approach allows for heterogeneous data entities of variable number.

The data associated with a set of media markers may additionally be tagged or indexed so as to allow for searches for subsets of data instances that match certain patterns. For example, a search criteria may indicate selection of comments on media markers that have been authored by a specific group of friends. In this example, the author may be represented by an element described by an XML schema, and the name values may be a set of contacts derived from a social networking friends list.

The Media Navigation System may provide a method for searching for media markers based upon search patterns associated with related data. The results of such a search may comprise a collection of related data objects. The Media Navigation System may furthermore allow these data objects to be displayed with a proximity to the nearest tile in the Media Navigation System display. For example, the system may show a symbol such as a plus sign to be displayed near a tile, indicating the presence of a sufficient number of data items under that tile, such as user comments within the time interval vicinity of the tile. When a user selects the plus sign in the interface, the Media Navigation System may display the set of data items in a list. Such an interface provides both a visual cue as to where the data items are located, as well as providing immediate access to only the data items existing within a certain time interval of the tile.

The Media Navigation System may also provide visual indicators around a tile indicating the relative density of aggregated related data items under such tile. For example, if one tile has ten comments associated with media markers within the tile's time interval, while another tile has five comments associated with its media markers, the first tile may display a “hotter” red colored border to indicate a higher density of content under itself, versus a “cooler” yellow border around the second tile. In another embodiment, a set of symbols and variable sized shapes may be employed to convey relative densities of related data items under neighboring tiles. One approach may involve displaying different sized dots to indicate relative densities.

The data items associated with a media marker may be independent of any particular Media Navigation System and its configuration parameters. This means that one user could configure his or her Media Navigation System in a particular way, and create a comment or other related data item relative to a media marker. Furthermore, this data item could be stored, and another user could retrieve his or her own custom configuration of a Media Navigation System, and load such data item associated with such media marker. Due to the fact that the second user's Media Navigation System may be configured to chop the same media object 16 into different sized intervals and tile representations at each zoom level, the result of displaying the first user's commented media marker in the context of the second user's Media Navigation System may result in the second user's display showing the comment to be located under a different tile, and at a different zoom level. This is OK, as the state of a Media Navigation System's display is independent of the data collection that is displays.

In one embodiment of the invention, a Media Navigation System may display advertisements (ads) in connection with navigation operations. For example, the system may insert ads in the stream of data being sent from the server 12 to the client 10, and the client 10 may display the ads as it is displaying returned sets of tiles. Ads may be displayed during the transitions from one zoom level to the next, for example, or in dynamic or static screen locations adjacent to the displayed tiles. Furthermore, when a user selects a tile and commands the system to “zoom in”, the selection of the ad may be based upon a number of contextual parameters, including the selected tile id, the media marker location associated with the tile, the values of data items related to the interval surrounding the tile, and the activity of other users who may have navigated to the same zoom level under the tile, within a specified period of time. The system may utilize data associated with a selected tile, and usage statistics on the zoom activity relative to a tile, to drive the selection process of an ad. An ad may be displayed while the system derives or retrieves the next set of tiles associated with the next zoom level.

A search function may identify a collection of related data objects that are associated with a set of media markers. In one embodiment, these may be comments created by different users, and associated with media markers of a specified media object. Furthermore, these media markers may coincide with a currently displayed tile in an active Media Navigation System instance. The system may provide a visual indicator of the presence of the data related to a displayed tile, as well as provide a command for changing the display to show a list or other suitable representation of such data. From this display, the user can invoke a command to return to the previous display, or may invoke one of a number of commands to edit the collection of related data items.

### Other Media Navigation System Commands

The system may also provide commands that accept media marker references as input in order to perform functions on the referenced media and/or markers. The Media Navigation System user interface may enable a user to select one or more tiles as inputs to a command. These tile selections may be mapped to selections of media markers associated with a specified media object. Furthermore, these media markers and referenced media object 16 may serve as inputs to commands.

For example, a “clip” command may take a selected “from tile”, and selected “to tile” as input, and generate a data structure defining a clip region of a referenced media object 16 which spans all the tiles in the range of the “from tile” to the “to tile”. Such a command would generate media marker references to identify a region for clipping. A “cut” command may take selected “from” and “to” tiles as described above, and package the associated markers as descriptors for where to cut a section out of a specified media object. A user may be able to retrieve a data structure describing such shortened media object, and display the media object 16 in the Media Navigation System with automatic filtering and removal of the tiles between the cut “from” and “to” locations.

### References to Media Navigation Systems

As was previously described, the system may provide a graphical user interface for presenting a Media Navigation System to a user via an interactive UI. Through the course of user interaction with a Media Navigation System, the state of the interface will change as a user progressively selects tiles and zooms in to different levels. Additionally, the Media Navigation System interface may provide access to a set of configuration parameters that allow the user to change the desired grid size (GS) and interval derivation rules. These parameters may cause the Media Navigation System to behave differently, causing it to derive personalized tiles, which comprise personalized media marker locations, intervals, and snippet data (e.g. images). These configuration parameters, as well as the navigation history describing the zoom path to a specified level, and tile selection, may be captured and formatted as a service request or method call. In one embodiment, a method call may be a URL representing a REST-based call to a service via the HTTP protocol on the Internet. Such a URL may describe the name of a service, and a set of parameters required to enable the system to invoke a Media Navigation System, and return it to the same configuration state, same target media object, same zoom path to a specified level, and same selected tile present when the URL was generated.

### Other Media Types

Although the above description is directed primarily to the use of the Media Navigation System with video objects, in alternative embodiments it may be used with other forms of media. Both video and other forms can generally be described as including stream-based data, wherein the content of a stream-based data object may be divided into discrete chunks and in which such chunks may be organized sequentially according to one or more parameters associated with the discrete chunks. The navigation method employs suitable graphical representations of the chunks for use in the user display.

The following may be considered to be examples of other forms of stream-based data objects: a text document, a tagged photo collection, and a playlist of videos. A text document can be easily divided into chunks according to page, paragraph, sentence, and word, and these chunks can be organized according to their character offset location within the document. The Media Navigation System may derive a tile representation for an interval of a text document by selecting a first sentence or phrase from that interval, and displaying this text in the space of the tile area. A tagged photo collection is naturally a collection of discrete image chunks—photos, and these images may be organized according to their tag values, such as time taken, and geo-location—latitude and longitude. For example, one way to order a tagged photo collection of a race event may be according to the chronology of when the photos were taken. Another way to order the photos in the same collection may be according to their position along a race course, from the start of the course to the end. A playlist of videos can be organized sequentially to form a “super video”, and be handled by the Media Navigation System as a single video.

What is claimed is:

1. A method of enabling a user to navigate a video object, comprising:
displaying a first set of tiles to the user, the first set of tiles including respective images from a first interval of the video object, the first interval including a plurality of sub-intervals collectively spanning the first interval, each sub-interval being associated with a respective distinct one of the tiles;
receiving a selection signal indicating that the user has selected one of the tiles; and
in response to receiving the selection signal, retrieving and displaying a second set of tiles to the user, the second set of tiles including respective images from the sub-interval associated with the selected tile.

2. A method according to claim 1, wherein the number of tiles in the second set of tiles is different from the number of tiles in the first set of tiles.

3. A method according to claim 1, wherein the sub-interval associated with the selected tile includes a plurality of further sub-intervals, each further sub-interval being associated with a respective distinct one of the tiles of the second set of tiles, the further sub-intervals all being of a uniform duration equal to a duration of the sub-interval associated with the selected tile divided by the number of tiles in the second set of tiles.

4. A method according to claim 1, wherein the sub-interval associated with the selected tile includes a plurality of further sub-intervals, each further sub-interval being associated with a respective distinct one of the tiles of the second set of tiles, the further sub-intervals being of generally non-uniform durations based on content of the video object.

5. A method according to claim 4, wherein the locations and durations of the further sub-intervals coincide with predefined boundaries of scenes or events in the content of the video object.

6. A method according to claim 4, wherein the locations and durations of the further sub-intervals coincide with media markers identifying locations of potential user interest or viewing activity in the video object.

7. A method according to claim 1, wherein selected ones of the first and second sets of tiles include respective graphical indicators indicating the existence of additional data associated with the respective tiles, and further comprising:
receiving an activation signal indicating that the user has activated a graphical indicator associated with one of the tiles; and
in response to receiving the activation signal, displaying the additional data associated with the respective tile.

8. A method according to claim 1, further comprising displaying a representation of an advertisement to the user, the representation being an advertisement tile and being displayed in a manner selected from the group consisting of (i) being added to or replacing one of the tiles of the second set of tiles, and (ii) as a transition between the displaying of the first and second sets of tiles and along with a user control that can be activated by the user to transition from displaying the advertisement tile to displaying the second set of tiles.

9. A method according to claim 8, wherein the advertisement is an advertisement video object having a plurality of sub-intervals, and further comprising:
receiving an advertisement selection signal indicating that the user has selected the advertisement tile; and
in response to receiving the advertisement selection signal, retrieving and displaying a set of advertisement tiles to the user, the set of advertisement tiles including respective images from the sub-intervals of the advertisement video object.

10. A method according to claim 1, further comprising playing a section of the video object corresponding to the interval represented by either the first or second set of tiles in response to initiating a play command while the respective set of tiles is displayed.

11. A method according to claim 1, further comprising playing a section of the video object corresponding to a sub interval by selecting a displayed tile for the sub-interval and initiating a play command.

12. A method according to claim 1, further comprising displaying a graphical area wherein a sub-area of the graphical area is colored differently from a remainder of the graphical area to indicate a size of an interval represented by a set of tiles relative to a size of the video object.

13. A method according to claim 12, wherein the graphical area is a rectangular bar shape and the sub-area is a smaller enclosed rectangular bar shape.

14. A method according to claim 12, further comprising:
enabling the user to grab a boundary of the sub-area and drag it to define a new sub-area of different size and/or position relative to the graphical area; and
upon such grabbing and dragging of the boundary by the user, retrieving and displaying a new interval of tiles of a new interval of the video object corresponding to the new sub-area.

15. A method of operating a server computer to enable a user to navigate a video object, comprising:
receiving a request from a client computer, the request identifying a main interval of the video object;
in response to receiving the request, calculating boundaries of a set of sub-intervals of the main interval, the sub-intervals collectively spanning the main interval;
for each of the sub-intervals, selecting a respective tile image and computing sub-interval meta-data, the sub-interval meta-data for each sub-interval identifying start and end times of a respective segment of the video object; and
creating a response and returning it to the client computer, the response including a collection of sub-interval data for the set of sub-intervals, the sub-interval data for each sub-interval including (i) an identifier of the respective tile image and (ii) the sub-interval meta-data of the sub-interval.

16. A method according to claim 15, wherein calculating the boundaries of the set of sub-intervals comprises computing a quantity, the quantity being the number of sub-intervals in the set.

17. A method according to claim 16, wherein computing the quantity includes:
comparing the duration of the main interval to at least a first threshold; and
if the duration of the main interval is less than the first threshold, then setting the quantity to be a first number, and otherwise setting the quantity to be a second number greater than the first number.

18. A method according to claim 16, further comprising computing a further interval being selected from a zoom-in interval, and zoom-out interval, and a pan interval for each of the sub-intervals and returning the further interval in the response for use by the client in generating a subsequent request, the zoom-in interval being computed for each sub interval and being equivalent to the sub interval, the zoom-out interval being computed for the main interval and being larger than the main interval, the pan interval being computed for the current main interval and being a selected one of a preceding or succeeding interval with respect to the main interval.

19. A method according to claim 15, further comprising computing an advertisement and including it in the response for use by the client in displaying the sub-interval data to a user.

20. A client computerized device, comprising:
a display device;
a selection device operative to enable a user to indicate selection of a graphical object displayed on the display device;
communications circuitry operative to enable the client computerized device to communicate with a server computerized device;
memory operative to store media navigation instructions; and
a processor for executing the media navigation instructions to cause the client computerized device to perform a media navigation method enabling a user to navigate a video object, the media navigation method comprising:
displaying a first set of tiles to the user on the display device, the first set of tiles including respective images from a first interval of the video object, the first interval including a plurality of sub-intervals collectively spanning the first interval, each sub-interval being associated with a respective distinct one of the tiles;
receiving a selection signal from the selection device indicating that the user has selected one of the tiles; and
in response to receiving the selection signal, communicating with the server computerized device to retrieve a second set of tiles, and displaying the second set of tiles to the user on the display device, the second set of tiles including respective images from the sub-interval associated with the selected tile.

21. A client computerized device according to claim 20, wherein the number of tiles in the second set of tiles is less than the number of tiles in the first set of tiles.

22. A client computerized device according to claim 20, wherein the sub-interval associated with the selected tile includes a plurality of further sub-intervals, each further sub-interval being associated with a respective distinct one of the tiles of the second set of tiles, the further sub-intervals all being of a uniform duration equal to a duration of the sub-interval associated with the selected tile divided by the number of tiles in the second set of tiles.

23. A client computerized device according to claim 20, wherein the sub-interval associated with the selected tile includes a plurality of further sub-intervals, each further sub-interval being associated with a respective distinct one of the tiles of the second set of tiles, the further sub-intervals being of generally non-uniform durations based on content of the video object.

24. A client computerized device according to claim 23, wherein the durations of the further sub-intervals coincide with predefined boundaries of scenes or sub-scenes in the content of the video object.

25. A client computerized device according to claim 23, wherein the durations of the further sub-intervals coincide with predefined media markers identifying locations of potential user interest in the video object.

26. A client computerized device according to claim 20, wherein selected ones of the first and second sets of tiles include respective graphical indicators indicating the existence of additional data associated with the respective tiles, and wherein the media navigation method performed by the processor further comprises:
receiving an activation signal indicating that the user has activated a graphical indicator associated with one of the tiles; and
in response to receiving the activation signal, displaying the additional data associated with the respective tile.

27. A client computerized device according to claim 20, wherein the media navigation method further comprises displaying a representation of an advertisement to the user, the representation being an advertisement tile and being displayed in a manner selected from the group consisting of (i) being added to or replacing one of the tiles of the second set of tiles, and (ii) as a transition between the displaying of the first and second sets of tiles and along with a user control that can be activated by the user to transition from displaying the advertisement tile to displaying the second set of tiles.

28. A client computerized device according to claim 27, wherein the advertisement is an advertisement video object having a plurality of sub-intervals, and wherein the media navigation method further comprises:
receiving an advertisement selection signal indicating that the user has selected the advertisement tile; and
in response to receiving the advertisement selection signal, retrieving and displaying a set of advertisement tiles to the user, the set of advertisement tiles including respective images from the sub-intervals of the advertisement video object.

29. A client computerized device according to claim 20, wherein the media navigation method further comprises playing a section of the video object corresponding to the interval represented by either the first or second set of tiles in response to initiating a play command while the respective set of tiles is displayed.

30. A client computerized device according to claim 20, wherein the media navigation method further comprises playing a section of the video object corresponding to a sub interval by selecting a displayed tile for the sub-interval and initiating a play command.

31. A client computerized device according to claim 20, wherein the media navigation method further comprises displaying a graphical area wherein a sub-area of the graphical area is colored differently from a remainder of the graphical area to indicate a size of an interval represented by a set of tiles relative to a size of the video object.

32. A client computerized device according to claim 31, wherein the graphical area is a rectangular bar shape and the sub-area is a smaller enclosed rectangular bar shape.

33. A client computerized device according to claim 31, wherein the media navigation method further comprises:
enabling the user to grab a boundary of the sub-area and drag it to define a new sub-area of different size and/or position relative to the graphical area; and
upon such grabbing and dragging of the boundary by the user, retrieving and displaying a new interval of tiles of a new interval of the video object corresponding to the new sub-area.

34. A server computerized device, comprising:
communications circuitry operative to enable the server computerized device to communicate with a client computerized device;
memory operative to store media navigation instructions; and
a processor for executing the media navigation instructions to cause the server computerized device to perform a media navigation method enabling a user to navigate a video object, the media navigation method comprising:
receiving a request from the client computerized device, the request identifying a main interval of the video object;
in response to receiving the request, calculating boundaries of a set of sub-intervals of the main interval, the sub-intervals collectively spanning the main interval;
for each of the sub-intervals, selecting a respective tile image and computing sub-interval meta-data, the sub-interval meta-data for each sub-interval identifying start and end times of a respective segment of the video object; and
creating a response and returning it to the client computerized device, the response including a collection of sub-interval data for the set of sub-intervals, the sub-interval data for each sub-interval including (i) an identifier of the respective tile image and (ii) the sub-interval meta-data of the sub-interval.

35. A server computerized device according to claim 34, wherein calculating the boundaries of the set of sub-intervals comprises computing a quantity, the quantity being the number of sub-intervals in the set.

36. A server computerized device according to claim 35, wherein computing the quantity includes:
comparing the duration of the main interval to at least a first threshold; and
if the duration of the main interval is less than the first threshold, then setting the quantity to be a first number, and otherwise setting the quantity to be a second number greater than the first number.

37. A server computerized device according to claim 34, wherein the media navigation method further comprises computing a further interval being selected from a zoom-in interval, and zoom-out interval, and a pan interval for each of the sub-intervals and returning the further interval in the response for use by the client in generating a subsequent request.

38. A server computerized device according to claim 34, wherein the media navigation method further comprises computing an advertisement and including it in the response for use by the client in displaying the sub-interval data to a user.

39. A method of enabling a user to navigate a stream-based data object, the stream-based data object being divided into discrete chunks organized sequentially according to one or more parameters associated with the discrete chunks, comprising:
displaying a first set of representations of the stream-based data object to the user, the first set of representations being taken from a first interval of the stream-based data object, the first interval including a plurality of sub-intervals generally spanning the first interval, each sub-interval being associated with a respective distinct one of the representations;
receiving a selection signal indicating that the user has selected one of the representations; and
in response to receiving the selection signal, displaying a second set of representations of the stream-based data object to the user, the second set of representations being taken from the sub-interval associated with the selected representation.

40. A method according to claim 39, wherein the stream-based data object is a text document and the discrete chunks are text chunks divided according to one or more of pages, paragraphs, sentences, the text chunks being organized according to respective character offset locations within the text document.

41. A method according to claim 40, wherein a tile representation for an interval of the text document is derived by selecting a first sentence or phrase from the interval.

42. A method according to claim 39, wherein the stream-based data object is a tagged photo collection organized according to respective tag values.

43. A method according to claim 43 wherein the tag values are selected from the group consisting of time of photo and location of subject photographed.

44. A method according to claim 39, wherein the stream-based data object is a playlist of videos organized sequentially to form a super video.
